(19) United States
(12) Patent Application Publication
(10) Pub. No.: US 2015/0120412 A1
(43) Pub. Date: Apr. 30, 2015

(54) ACTIVE IMPROVEMENT OF COUPONS BASED UPON CUSTOMER ASSISTED RESOLUTION OF INFORMATION GAPS

(71) Applicant: International Business Machines Corporation, Armonk, NY (US)

(72) Inventors: Ajay Ashok Deshpande, Yorktown Heights, NY (US); Kimberly D. Hendrix, Yorktown Heights, NY (US); Herbert Scott McFaddin, Yorktown Heights, NY (US); Chandrasekhar Narayanaswami, Yorktown Heights, NY (US)

(73) Assignee: International Business Machines Corporation, Armonk, NY (US)

(21) Appl. No.: 14/213,338

(22) Filed: Mar. 14, 2014

Related U.S. Application Data
(60) Provisional application No. 61/897,973, filed on Oct. 31, 2013.

(51) Int. Cl. G06Q 30/02

(52) U.S. Cl. CPC G06Q 30/0211
USPC 705/14.13

(57) ABSTRACT

A method and system includes providing an electronic coupon to a customer, providing the customer an option to improve the coupon in exchange for a customer response, performing an analysis of at least one of information known about the customer, coupon issuer information, and contextual information, and identifying an information gap item which is at least one of missing, incomplete, and not updated within a time range, generating a customer response requirement based upon the information gap item, displaying the response requirement to the customer, and upon the customer providing a response which satisfies the response requirement, improving the coupon based on the customer response.

The present application claims priority from U.S. Provisional Application No. 61/897,973, filed on Oct. 31, 2013, the disclosure of which is incorporated herein by reference.

### BACKGROUND OF THE INVENTION

1. Field of the Invention

The present invention generally relates to coupons. In particular, an exemplary aspect of this invention relates to active coupons which can change based on a customer's actions.

2. Description of the Related Art

In recent years there has been an increased interest in coupon use. Coupons have traditionally been used to attract customers to visit retail stores, to introduce a product to a customer for the first time, or to sacrificially offer a lower price on a given product with the hope of the customer spending more on collateral products.

Conventional coupons can be used to gain information about the customer. However, the information from a conventional coupon is gained after the coupon is redeemed and normally limited to the knowledge that customer X will buy product P at price Y.

In recent years retailers have increased their focus on gaining information about customers. For example retailer loyalty cards provide a rich mechanism of gaining information about customer purchasing habits, primarily by providing a mechanism tracking customer purchases in exchange for discounts specific to loyalty program members.

### SUMMARY OF THE INVENTION

In view of the foregoing, and other, exemplary problems, drawbacks, and disadvantages of the conventional systems, it is an exemplary feature of the present invention to provide a method and system for making coupons a more effective mechanism for gaining information about the customer.

A first exemplary aspect of the present invention, to achieve the above features and objects, described herein is a method including providing an electronic coupon to a customer, providing the customer an option to improve the coupon in exchange for a customer response, performing an analysis of at least one of information known about the customer, coupon issuer information, and contextual information, and identifying an information gap item which is at least one of missing, incomplete, and not updated within a time range, generating a customer response requirement based upon the information gap item, displaying the response requirement to the customer, upon the customer providing a response which satisfies the response requirement, improving the coupon based on the customer response.

Another exemplary aspect of the invention is a non-transitory computer readable storage medium tangibly embodying a program of machine-readable instructions executable by a digital processing apparatus to perform a method, the method including providing an electronic coupon to a customer, providing the customer an option to improve the coupon in exchange for a customer response, performing an analysis of at least one of information known about the customer, coupon issuer information, and contextual information, and identifying an information gap item which is at least one of missing, incomplete, and not updated within a time range, generating a customer response requirement based upon the information gap item, displaying the response requirement to the customer, and upon the customer providing a response which satisfies the response requirement, improving the coupon based on the customer response.

Another exemplary aspect of the invention is a system including a memory including a customer information profile, a processor configured to generate an information gap item for a customer based on the customer information profile, and generate a coupon including an offer to improve the coupon for the information gap item, and an input/output interface configured to transmit a user response to the processor such that, if an offer to improve the coupon is accepted by the user, then the processor stores the response in the memory, and to transmit to the user an improved coupon.

These features may provide a coupon system which enables the gathering specific information from the customer.

### BRIEF DESCRIPTION OF THE DRAWINGS

The foregoing and other purposes, aspects and advantages will be better understood from the following detailed description of exemplary embodiments of the invention with reference to the drawings, in which:

FIG. 1 illustrates an exemplary method 100 of utilizing an active coupon according to an exemplary embodiment of the invention;

FIG. 2 illustrates exemplary images with respect to an active coupon according to an exemplary embodiment of the invention;

FIG. 3 illustrates an exemplary system 300 which handles an active coupon according to an exemplary embodiment of the invention; and

FIG. 4 illustrates an exemplary flow 400 for coupon issuance and/or improvement/exchange.

### DETAILED DESCRIPTION OF AN EXEMPLARY EMBODIMENT(S) OF THE INVENTION

Conventional coupons can provide some information about customer purchases once they are used. However, they have been lacking their ability to provide valuable and specific customer data in exchange for the benefit they provide.

In an exemplary embodiment of the invention, coupons are viewed as an active process. These coupons can be used by the customer “as is” or “improved” by the customer by providing something to the issuer, such as information.

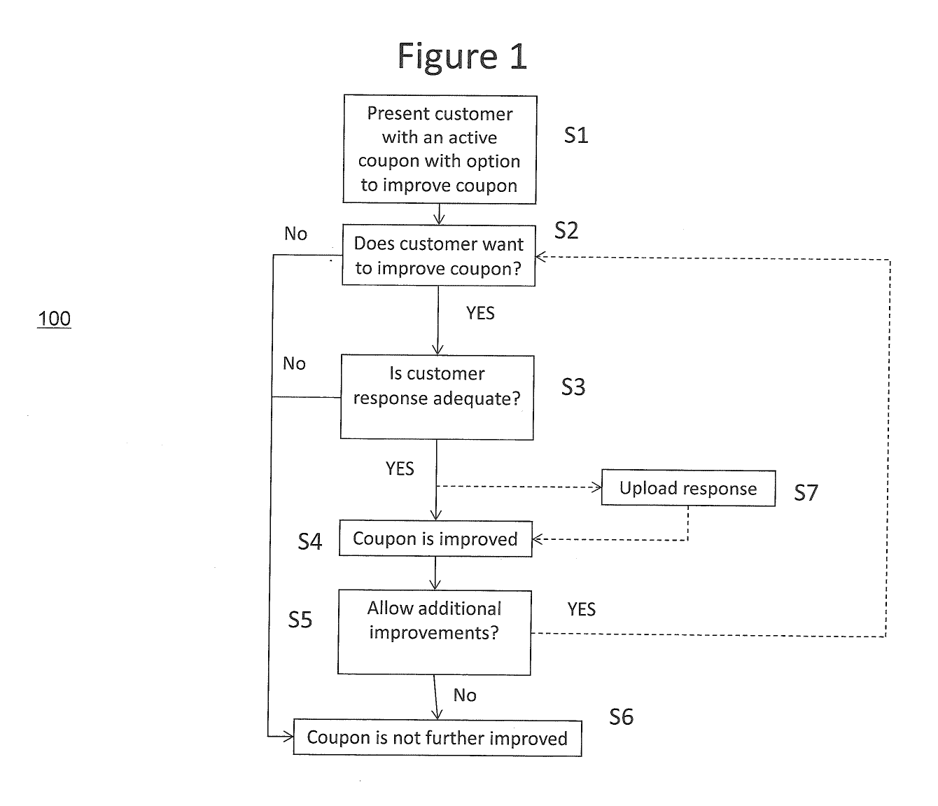

Referring now to the drawings, and more particularly to FIGS. 1-4, there are shown exemplary embodiments of the method and structures according to the present invention.

FIG. 1 illustrates an exemplary method 100, according to an exemplary aspect of the invention. In particular the method 100 includes a flowchart relating to an active coupon.

As illustrated in FIG. 1, the customer is presented with an active coupon which has a notice that it can be improved by completing an additional customer action (S1). The additional customer action is usually providing or permitting access to information about the customer, however other forms of customer action are possible. For example, the customer could be asked to describe how far they drive to the retailer, or list competitors that they consider in relation to the coupon issuer.

The customer, if they decide to improve the coupon, is given one or more options (e.g., questions to answer) which can improve the coupon (S2). The options presented may be standardized or based on the customer's profile so as to add missing information.

If the customer decides not to improve the coupon, then the coupon is not improved (S6) (e.g., retains its current value). If the customer provides an adequate response (S3), the active coupon will be improved (S4) (e.g., replaced or upgraded to a different, usually more valuable, coupon).

This process can be repeated (S5), allowing the customer to provide multiple responses to multiple offers, either from the selection of original response options, or new response options based on the customer's previous response. If the customer decides to not improve the coupon at any point, then the value of the coupon is not improved further (S6).

The customer response can be used in an analytical system to predict, for example through probability analysis, the future buying behaviors of the customer (S7). This information can also be used to calculate the coupon improvement (e.g., what the improvement will be).

The type of improvement applied to the coupon is not particularly limited. For example, the coupon may be improved by a set amount, an amount based on a scoring of the customer's response, a percentage of the monetary value of the information provided by the customer, or to an alternate offer (e.g., different brand or product, or a % off instead of a dollar amount).

The form of the coupon is not particularly limited. For example, the coupon may be a printed coupon or an electronic coupon.

Similarly, the manner in which the information or other user response is conferred is not particularly limited. For instance, the user may enter an answer online, through a mobile device application, text, phone call, on a printed fond or a physical coupon, directly at the retailer, or any other acceptable way.

In exemplary embodiments, the active coupon can be a single use coupon or a multiple use coupon. In the case of multiple use coupons, the uses may be fixed or may vary depending on the response given by the customer (e.g., the more valuable the answer, the more uses the coupon is granted).

The active coupon may have a unique identifier code. The unique code may or may not change when the coupon is improved. The customer responses for a particular coupon are related to the code and the redemption of the coupon may be recorded in association with the code.

To improve the coupon, coupon issuers can determine the value of the information relative to the advantages conferred to the customer by the coupon. The issuer may also improve the coupon by a set amount. Additionally, the issuer can determine the increase in value by determining the value of the information provided and then increase the value of the coupon by a bracketed range. In some embodiments, the improvement of the coupon may be a change in product based on the customer response information, such as changing the coupon to apply to a certain brand.

As noted above, upon improving the coupon the customer may be given the option of further improving the coupon by providing an additional response/information. During any or all of the improvement offers, the customer may be given one or more questions or options for improving the coupon which the user can select.

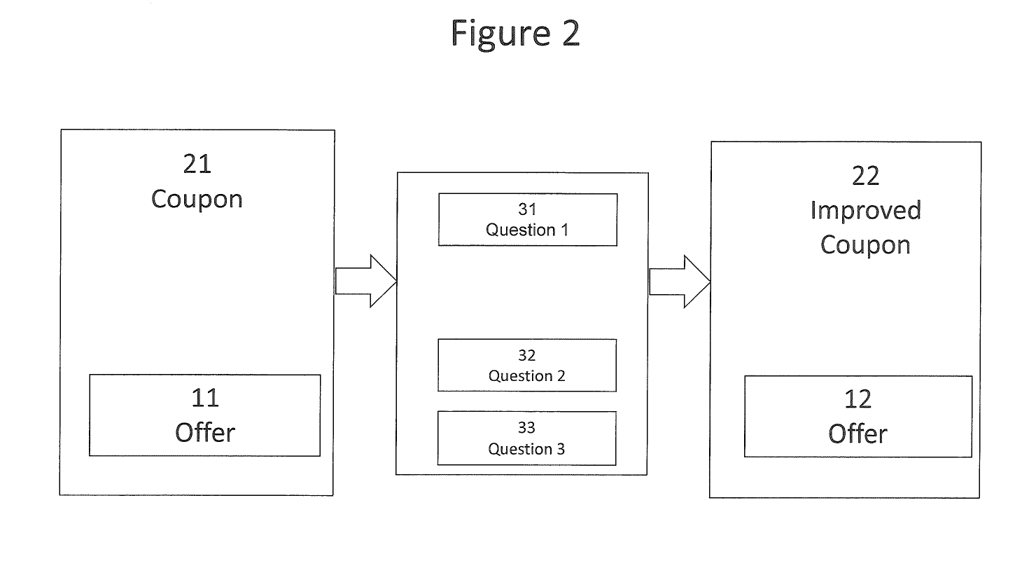

FIG. 2 illustrates an example of an active coupon at initial receipt, the offer questions, and the resulting improved coupon. In this illustration, a customer is provided with a coupon 21 electronically having an offer 11, with the option of improving the coupon 21. The coupon 21 may recite, for example “Print this coupon and get a large coffee for $1.00 off at your neighborhood XYZ Coffee Shop” in main area of coupon 21, and “Improve this offer!” in the area of offer 11. Upon acceptance of the coupon and the decision to improve the coupon, the customer is given a set of three questions 31 (e.g., “What is your favorite coffee bean? Columbian, Ethiopian, Espresso”), 32 (e.g., “How often do you visit XYZ Coffee Shop?”), and 33 (e.g., “What is your zip code?”), of which the customer may select which question(s) to answer. Based upon the customer's response the coupon is improved from one dollar off of the product to a coupon for two dollars off the product. The new “improved” coupon 22 also gives the customer the option of further improving the coupon 12. The improved coupon 22 may recite, for example “Print this coupon and get a large coffee for $2.00 off at your neighborhood XYZ Coffee Shop.” in main area of coupon 22, and “Improve this offer!” in the area of offer 12.

The manner in which the active coupons are offered to a customer is not particularly limited. For example, the customer can be sent the coupon by a third party, a retailer, and/or consumer packaged goods companies. The coupons can be issued at the point of sale by a store, through print, or electronically.

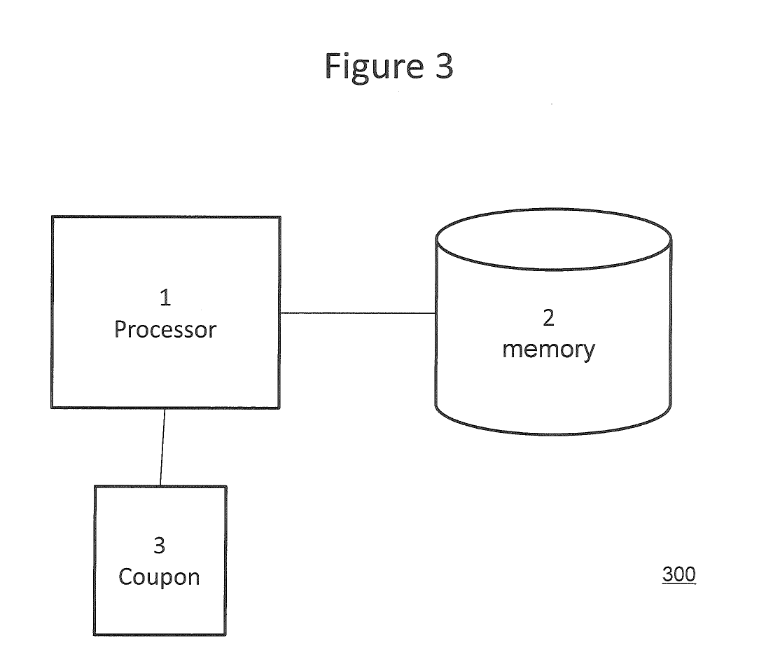

FIG. 3 illustrates a method 300 according to an exemplary aspect of the invention. As illustrated in FIG. 3, a processor 1 can be used to retrieve and send data from a database or memory 2 which is then used to generate coupon 3. Processor 1 utilizes information from memory 3 to determine the initial offer, the questions if the offer is accepted, and the new coupon information. The processor 1 also enters the user's response, lack of response, and response information into memory 3.

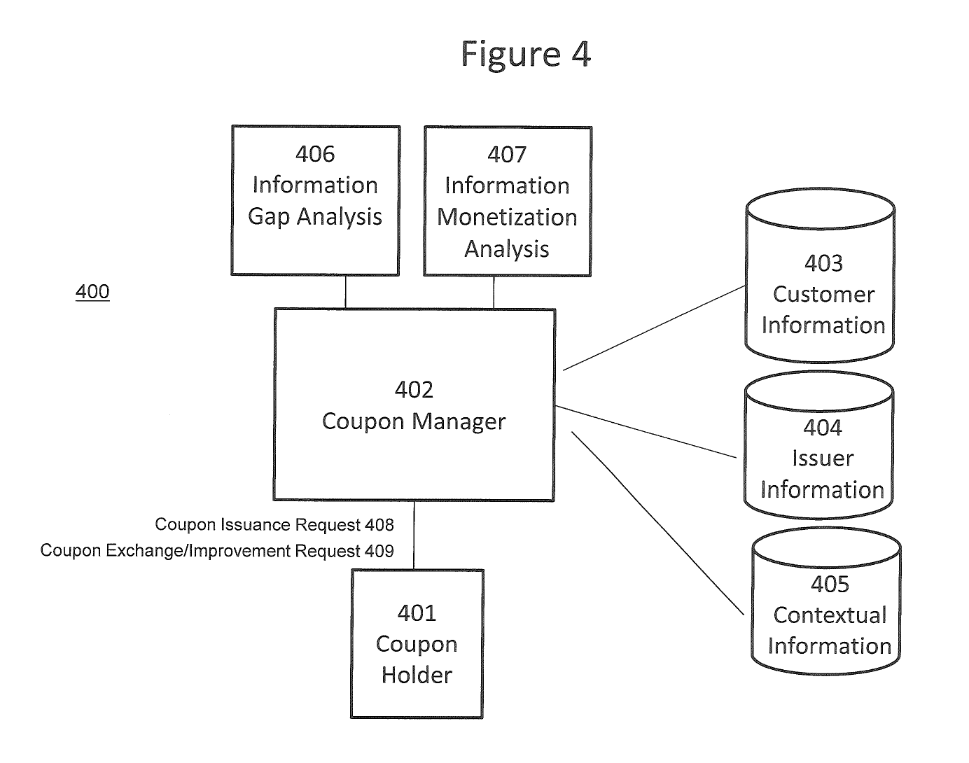

FIG. 4 illustrates a processing flow 400 for coupon issuance and/or improvement/exchange. In this flow 400, a coupon holder 401 sends a request to a coupon manager component 402. The coupon holder 401 could be an individual customer or an agent acting on behalf of a customer such as a computer application. Such an application could be either web-based or mobile, or part of a larger application that assists the user (e.g. a virtualized shopping assistant, personal advisor, or digital wallet application). The request sent to the coupon manager could be for example, a request for the initial issuance of the coupon 408 or a request to exchange or improve an existing coupon 409.

The coupon manager component 402 receives the request and formulates a response in the form of an initial coupon or an improved version of an existing coupon or an exchanged coupon. The coupon manager consults several data sources to make its decision. For example, the coupon manager may consult information 403 about the customer 401 that is holding the existing coupon or making the initial request by extracting a customer record from the customer information store 403.

This information may be incomplete and indicate additional information that is needed to more fully understand the customer making the request. For example, the customer record may contain blank fields, or attributes that have not been set. The customer record may also contain fields that are stale; meaning their most recent time of update is beyond a desired range. For example, the customer record may be found to have a missing zip code (“ZipCode=null”) or other address information. The customer record may have a missing value in an attribute, for example: “FavoriteCoffeeBean=UNKNOWN”. The customer record may also have a “stale” data value such as “CustomerProfession=ComputerScientist”, in which a customer attribute is known, but which has not been updated recently. Note that overall, the example customer record displays three attributes “ZipCode”, “FavoriteCoffeeBean”, and “CustomerProfession” for which it would be desirable to gain further knowledge.

The coupon manager can also consult information about the coupon issuer 404 (the store, manufacturer, or other entity which is issuing the coupon). This information may or may not coincide with the customer information 403. This information can also indicate data elements that are incomplete, for example, indicating that a store may need deeper knowledge about the spending habits of certain demographic constituencies among its customer base. For example, the store information record may have an attribute “AverageFrequencyOfCustomerVisit=2.1 Days” that has a running value, but which must be updated frequently to keep an accurate picture of customer activity. Note that in summary, the issuer record displays one or more attributes such as “AverageFrequencyOfCustomerVisit” for which it would be desirable to gain further knowledge, similar to the customer record.

The coupon manager may also consult additional contextual information 405 from a broad variety of sources, for example, demographic databases, census databases, weather information, location of the user, which application the user is using, how close the user may be to making a purchase, what are their past purchases, etc. This information may indicate particularly germane information that may impact the issuer, customer, or other entities.

Upon gathering information elements 403, 404, and 405, the coupon manager needs to assemble those into an appropriate response coupon. The coupon manager can make use of additional decision-making components in this process. In particular, the coupon manager may consult a gap analysis component 406 that provides an information gap analysis. This component looks at the information elements previously gathered and determines that the information is partially missing or could be improved in some way.

For example, it could determine that it would be useful to know which variety of coffee bean the user prefers due to the missing value in the “FavoriteCoffeeBean” field in the customer record. Based on the information gap analysis an information gap set can be created which includes information which is missing or needs to be updated for a customer. The information may need to be updated if the information currently contained is invalid or older than a certain period of time.

This gap analysis can be made more precise based upon knowledge of which coupon is being tendered in a coupon improvement or exchange request 409. For example, if the original coupon is a coffee offer, the gap analyzer 406 could suggest asking about the flavor preference. Additional types of information gaps could include price sensitivity, brand sensitivity, time of day/week/month/year shopping preferences, packaging preferences, ideal portion sizes, preferred colors, sizes, styles, textures, etc.

Additionally, the coupon manager can consult information monetization components 407 that help it to weigh and/or monetize the gain that would be realized if particular gaps in the information supply were filled. The output of the information monetization modules would be a weighting factor placed upon each item deduced in the gap analysis components. For example, such a weighting would inform the coupon manager that it is more useful to know flavor preferences of a coffee customer than to know the profession of the customer. This decision could be personalized to the user, and may vary from user to user. The information monetization components could also make weighting decisions based upon the way in which a gap occurs—for example, providing higher weight to attributes which are missing than to attributes which are simply stale.

The coupon manager concludes the process by making an analytical decision about the response coupon based upon its inputs from the information sources as well as the analysis components and issues its response to the initial caller. This process can also include the act of recording the altered/replaced/issued coupon and placing an appropriate data record in the coupon store of the issuer and/or the digital wallet of the user, as well as printing the coupon if the setting is physical.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, PHP, Javascript, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), both wired and wireless, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described in terms of exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method comprising:
providing an electronic coupon to a customer;
providing the customer an option to improve the coupon in exchange for a customer response;
performing an analysis of at least one of information known about the customer, coupon issuer information, and contextual information, and identifying an information gap item which is at least one of missing, incomplete, and not updated within a time range;
generating a customer response requirement based upon the information gap item;
displaying the response requirement to the customer; and
upon the customer providing a response which satisfies the response requirement, improving the coupon based on the customer response.

2. The method of claim 1, further comprising assigning a numerical weight to the information gap item indicating an importance of the information item to the coupon issuer.

3. The method of claim 1, further comprising assigning monetary or other values to the information gap item.

4. The method according to claim 1, wherein the customer response requirement includes a question to answer, info′ nation elements to provide, or a plurality of questions to answer or information elements to provide of which the customer can choose at least one thereof.

5. The method according to claim 4, wherein the customer information includes at least one of information on a desire or non-desire for one or more products, demographic information about the customer, information about past purchases of the customer, and information about future purchases, purchase intentions, or preferences of the customer.

6. The method according to claim 1, wherein the customer response requirement includes allowing access to customer information streams such as location reports and/or social media posts.

7. The method according to claim 1, wherein the improving the coupon includes increasing a value of the coupon based on the customer response.

8. The method according to claim 1, wherein the improving the coupon includes providing a different coupon based on the customer response.

9. The method according to claim 1, wherein the performing the analysis includes looking-up in a customer profile management database information relating to the customer, and
wherein the method further comprises entering the response in the customer profile management database.

10. The method according to claim 1, wherein the value of the improved coupon is presented to the customer before the customer response.

11. The method according to claim 1, wherein the value of the improved coupon is not presented to the customer before the customer response.

12. The method according to claim 1, further comprising recording the presentation of the coupon to the customer and/or recording the acceptance of the coupon by the customer.

13. The method according to claim 1, further comprising repeating the providing the customer the option to improve the coupon and the improving the coupon.

14. The method according to claim 1, wherein the providing the coupon is based upon initial information related to the customer.

15. The method according to claim 1, wherein the providing the coupon is based on the customer providing an initial information.

16. The method according to claim 1, further comprising calculating a future buying behavior based on the customer response.

17. A non-transitory computer readable storage medium tangibly embodying a program of machine-readable instructions executable by a digital processing apparatus to perform a method, the method comprising:
providing an electronic coupon to a customer;
providing the customer an option to improve the coupon in exchange for a customer response;
performing an analysis of at least one of information known about the customer, coupon issuer information, and contextual information, and identifying an information gap item which is at least one of missing, incomplete, and not updated within a time range;
generating a customer response requirement based upon the information gap item;
displaying the response requirement to the customer; and
upon the customer providing a response which satisfies the response requirement, improving the coupon based on the customer response.

18. The non-transitory computer readable storage medium according to claim 17, wherein the performing the analysis includes looking-up in a customer profile management database information relating to the customer.

19. The non-transitory computer readable storage medium according to claim 17, wherein the coupon has a set value before the improving of the coupon.

20. A system comprising:
a memory including a customer information profile;
a processor configured to generate an information gap item for a customer based on the customer information profile, and generate a coupon including an offer to improve the coupon for the information gap item; and
an input/output interface configured to transmit a user response to the processor such that, if an offer to improve the coupon is accepted by the user, then the processor stores the response in the memory, and to transmit to the user an improved coupon.
